(19) United States
(12) Patent Application Publication
(10) Pub. No.: US 2012/0102658 A1
(43) Pub. Date: May 3, 2012

(54) MATTRESS CORE

(75) Inventors: George Mantzis, Campbellfield (AU); Konstantinos Mantzis, Campbellfield (AU)

(73) Assignee: Mantzis Holdings Pty Ltd., Melbourne (AU)

(21) Appl. No.: 13/097,744

(22) Filed: Apr. 29, 2011

Related U.S. Application Data
(60) Provisional application No. 61/329,349, filed on Apr. 29, 2010.

(51) Int. Cl. A47C 23/00; B23P 11/00

(52) U.S. Cl. 5/720; 29/525.01; 29/525.13

(57) ABSTRACT

A mattress core including an array of strings of pocket springs extending in parallel across the mattress core; and a fastener coupling the array of pocket springs together, wherein peripheral pocket springs located in peripheral sections of the array are stepped down from crown pocket springs which are framed by the peripheral pocket springs.

This application claims benefit of U.S. Ser. No. 61/329,349, filed 29 Apr. 2010 and which application is incorporated herein by reference. To the extent appropriate, a claim of priority is made to the above disclosed application.

### TECHNICAL FIELD OF THE INVENTION

This invention relates to a mattress core and to a method of manufacturing a mattress core.

### BACKGROUND OF THE INVENTION

Mattress cores, for example, have previously included an array of individually pocketed springs. In such mattress cores, each pocket spring typically includes a spring encased within a fabric sack. A variety of techniques have evolved for the manufacture of pocketed springs. Some of these techniques teach the creation of the pockets within the fabric plies prior to insertion of the wire spring and others teach the insertion of the coaxially compressed wire springs between the plies of the strip and the subsequent creation of the pockets by stitching the two plies to each other along transverse lines between adjacent springs. In either technique, the pocket is closed after the insertion of the spring, usually by stitching the two plies together along a line parallel to the free edges of the plies.

U.S. Pat. No. 4,234,983, for example, teaches a manufacturing technique for a mattress core having an array of pocketed springs. This document teaches a technique for manufacturing a string of pocketed springs in which the overlaid fabric plies are secured to each other along the transverse and longitudinal lines of attachment to by thermal welding rather than by the use of stitching, as had conventionally been done. In particular, this document teaches a string of pocketed springs in which the pocket fabric is thermally weldable to itself so that the two plies of fabric of the folded strip in which the pockets are defined may be secured together without the necessity for stitching. In doing so, a stronger bond than is achieved when compared with sewing the same fabric material. At the same time, the elimination of any need for the thread and the sewing apparatus which was necessary to the manufacture of upholstery springs of this type.

The above-mentioned techniques may improve efficiency of production mattress cores. However, the above-described techniques may not be able to adequately control the compression properties of the resultant mattress core to suit one or more load requirements. To this end, it is not uncommon for two people to have different preferences when it comes to firmness of a mattress. That is, some people prefer a softer mattress and others prefer a harder mattress. This can make shopping for a mattress difficult when the mattress is to be shared by two people. This is particularly the case when the mattress is to be shared by a man and a woman having significantly different body sizes. In this situation, a mattress that is considered to have an adequate firmness by the larger of the two may be considered too hard for the lighter of the two. It is difficult to find a single mattress that satisfies the requirements of both parties.

The mattresses can, through wear and tear, visually sag when unloaded. That is, when the mattress is not bearing the weight of a person, for example. A sagging mattress is not typically aesthetically pleasing and would normally the owner to replace it. It is generally desirable to overcome problems associated with sagging mattresses.

Mattresses come with a variety of top layers attached to them. These top layers, depending on their design, add varying amounts of cushioning to the mattress. While the construction of the mattress core may be of a totally firm, for example, the top layer can provide extra padding. So called “Euro Tops” and “Pillow Tops”, for example, are just two of mattresses that include such top layers.

The primary difference between Euro and Pillow is in the stitching, Euro tops are stitched directly to the mattress top with no additional materials or gap between the top layer and the mattress itself. A Pillow Top topping is affixed to a layer all its own, which is attached to the mattress proper, with a gap between the two. A Euro Top mattress lacks the gap or additional material between the mattress frame and the cushioned top. A Pillow Top may appear to sit higher and be thicker than a Euro Top and may feel slightly more plush due to the added space between the two parts of the mattress.

It is generally desirable to improve the manufacturing steps involved in construction of Euro Top and Pillow Top mattresses. It is also desirable to manufacture Euro Top and Pillow Top mattresses having crowned upper surfaces. The crowned upper surface is generally aesthetically pleasing.

It is generally desirable to overcome or ameliorate one or more of the above mentioned difficulties, or at least provide a useful alternative.

### SUMMARY OF THE INVENTION

In accordance with one aspect of the invention, there is provided a mattress core including:
(a) an array of strings of pocket springs extending in parallel across the mattress core; and
(b) a fastener coupling the array of pocket springs together,
   wherein peripheral pocket springs located in peripheral sections of the array are stepped down from crown pocket springs which are framed by the peripheral pocket springs.

Preferably, the crown pocket springs are substantially the same height.

Preferably, the peripheral pocket springs frame four sides of the crown pocket springs.

Preferably, the peripheral pocket springs frame three sides of the crown pocket springs.

Preferably, the array is formed in first and second halves, each having peripheral pocket springs located in non-adjoining peripheral sections of the array.

In accordance with one aspect of the invention, there is provided a mattress including the above described mattress core.

In accordance with another aspect of the invention, there is provided a method of manufacturing a mattress core including the step of coupling a series of strings of pocket springs together with a fastener to form an array of strings of pocket springs, wherein peripheral pocket springs located in peripheral sections of the array are stepped down from crown pocket springs which are framed by the peripheral pocket springs.

Preferably, the crown pocket springs are substantially the same height.

Preferably, the array is formed in first and second halves, each having peripheral pocket springs located in non-adjoining peripheral sections of the array.

Preferably, the peripheral pocket springs are stepped down from the crown pocket springs on top and bottom sides of the mattress core.

Preferably, first and second halves of the array each include a central cluster of pocket springs, a rate of springs of pocket springs of the central cluster the first one of said halves being less than a rate of springs of pocket springs of the central cluster of the second one of said halves.

### BRIEF DESCRIPTION OF THE DRAWINGS

Preferred embodiments of the present invention are hereafter described, by way of non-limiting example only, with reference to the accompanying drawing in which:

FIG. 1 is a plan view of a mattress core;

FIG. 2 is an end view of the mattress core shown in FIG. 1;

FIG. 3 is a side view of a spring of the mattress core shown in FIG. 1;

FIGS. 4a to 4f are plan views of a string of the mattress core shown in FIG. 1 arranged in different stages of manufacture;

FIGS. 5a to 5c are plan views of sections of a string of the mattress core shown in FIG. 1 arranged in conditions of manufacture;

FIGS. 6a to 6c are plan views of the sections shown in FIGS. 5a to 5c arranged in other conditions of manufacture;

FIGS. 7a to 7c are plan views of a string of the mattress core shown in FIG. 1 arranged in different stages of manufacture;

FIGS. 8a and 8b are side views of a mattress core construction frame with stings of the mattress core shown in FIG. 1 assembled thereon;

FIG. 9 is a plan view of two halves of an array of pocket springs of the mattress core shown in FIG. 1;

FIG. 10 is a plan view of the two halves of the array of pocket springs shown in FIG. 9 framed in a box;

FIG. 11 is a plan view of the two halves of the array of pocket springs shown in FIG. 10 arranged in another condition of manufacture; and

FIGS. 12 to 14 are end views of alternative mattress cores.

### DETAILED DESCRIPTION OF PREFERRED EMBODIMENTS OF THE INVENTION

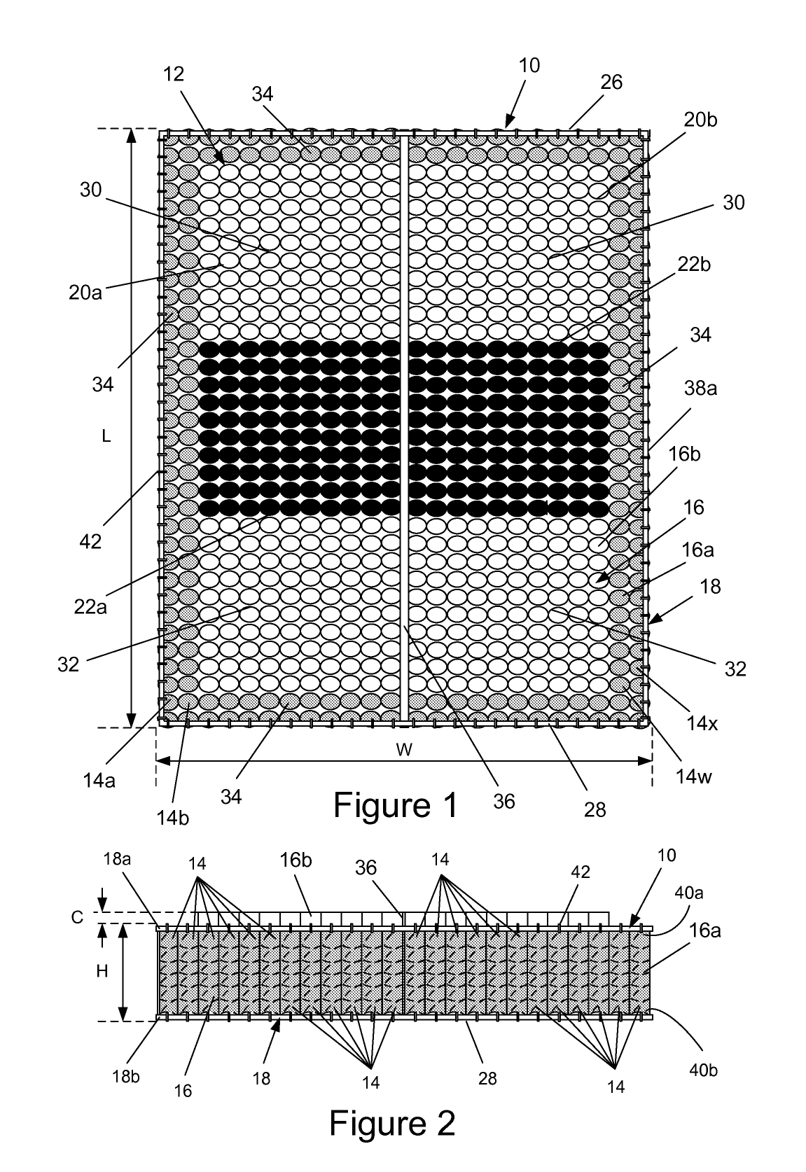

The mattress core 10 shown in FIGS. 1 and 2 forms part of a mattress (not shown). The mattress core 10 includes an array 12 of strings 14 of pocket springs 16 extending in parallel across the mattress core 10, and a fastener 18 coupling the array 12 of pocket springs 16 together. As particularly shown in FIG. 2, peripheral pocket springs 16a located in peripheral sections of the array 12 are stepped down from crown pocket springs 16b which are framed by the peripheral pocket springs 16a.

Advantageously, the peripheral pocket springs 16a and the crown pocket springs 16b assist in manufacture of Euro Top and Pillow Top mattresses (not shown). Further, the crown pocket springs 16b form a crown for the resultant mattress (not shown). The crown results in an aesthetically mattress and inhibits sagging of the mattress.

In order to provide a mattress that is suitable for two people that have different preferences when it comes to the firmness of a mattress, the mattress core 10 is formed in first and second halves 20a, 20b. A rate of springs 24 of crown pocket springs 16b of the first half 20a of the mattress core is less than a rate of springs 24 of crown pocket springs of the second half 20b of the mattress core. The rate of a spring is the change in the force it exerts, divided by the change in deflection of the spring. That is, it is the gradient of the force versus deflection curve. As such, the first half 20a of the mattress will be softer than the second half 20b of the mattress.

To further change the firmness of the mattress, first and second halves 20a, 20b of the array 12 include respective central 22a, 22b; head 30a, 30b; and foot 32a, 32b clusters of crown pocket springs 16b. The rates of springs in the central 22a, 22b; head 30a, 30b; and foot 32a, 32b clusters of crown pocket springs 16b can be selected to finely tune the firmness of the mattress core 10.

Any suitable combination of rates of springs for the central 22a, 22b; head 30a, 30b; and foot 32a, 32b clusters of crown pocket springs 16b can be selected to finely tune the firmness of the mattress core 10. However, one particular combination is described below for illustrative purposes. Also, the description of the mattress core 10 provided below is provided with reference to the strings 14 extending between a head 26 and foot 28 of the mattress core 10. However, the strings 14 could, alternatively, extend across the mattress core 10.

Rates of springs 24 of the head and foot clusters 30, 32 of pocket springs of the first half 20a of the array 12 are less than rates of springs 24 of central cluster 22a of pocket springs 16. Similarly, rates of springs 24 of the head and foot clusters 30, 32 of pocket springs of the second half 20b of the array 12 are less than rates of springs 24 of central cluster 22a of pocket springs 16. As such, head and foot sections 30, 32 of the mattress core 10 are softer than respective central sections 22a, 22b of the mattress core 10.

Springs 24 of the peripheral pocket springs 16a in the peripheral section 34 have a rate less than the rate of springs 24 of the head and foot clusters 30, 32 of the first and second halves 20a, 20b of the array 12. As such, peripheral sections 34 of the mattress core 10 are softer than respective head and foot sections 30, 34 of the mattress core 10.

The strings 14 include combinations of pocket springs 16 from the head, foot and central clusters 30, 32, 22a, 22b. Each pocket string 14 also includes peripheral pocket springs 16a. For example, a centrally disposed string 14 of pocket springs in the first half 20a includes pocket springs in the head 30, central 22a and foot 32 clusters as well as peripheral pocket springs 16a. A string 14 of pocket springs 16 in the peripheral section 34 of the first half 20a, includes border pocket springs 16b only.

The first and second halves 20a, 20b of the mattress core 10 are separated by a barrier 36. The barrier 36 is a section of foam. Alternatively, the barrier is any other suitable resiliently compressible material.

The fastener 18 includes top and bottom rectangular peripheral bands 18a, 18b respectively coupled to top and bottom sections 40a, 40b of peripheral pocket springs 16a of the array 12. The top and bottom rectangular peripheral bands 18a, 18b are respectively coupled to top and bottom sections 40a, 40b of peripheral pocket springs 16b with clips 42. As described below in further detail, opposed articular surfaces 74 of pocket springs 16 in opposed strings 14 of the array 12 are coupled together with an adhesive.

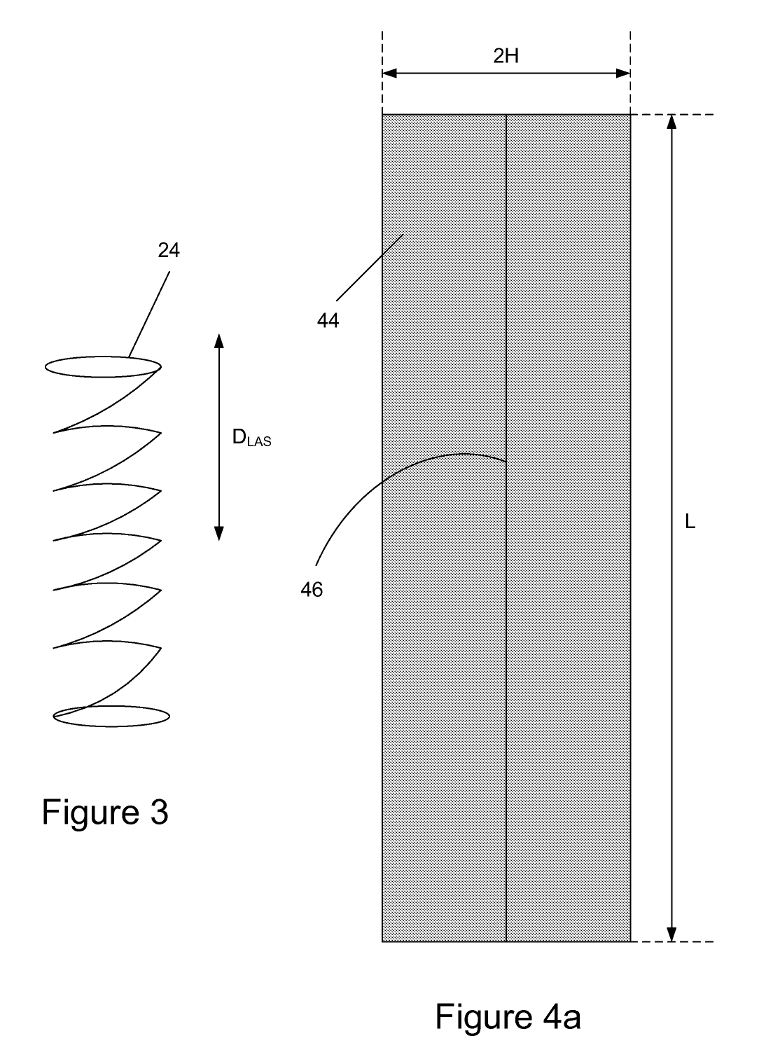

As particularly shown in FIG. 3, the springs 24 are preferably helical coils. The springs 24 formed using known apparatus (not shown) which takes a continuous length of metal wire and produces a helical coil. The coils are made from annealed metal and then treated with heat after fabrication. The apparatus used to manufacture the springs is know in the art and is not described here in detail.

The apparatus produces springs having different rates for use in the different sections of the mattress core. That is, the apparatus produces springs 24 for the pocket springs 16 having the following thickness:

a. Springs 24a of the border 34=2.5 mm to 5 mm;
b. Springs 24b of the head cluster 30=1 mm to 2.3 mm;
c. Springs 24c of the foot cluster 32=1 mm to 2.3 mm;
d. Springs 24di of the first central cluster 22a=1 mm to 2.3 mm; and
e. Springs 24dii of the second central cluster 22b=1 mm to 2.3 mm.

As above-mentioned, the springs 24di for the central cluster 22a have a lesser rate than springs 24dii for the central cluster 22b. In order to facilitate this, the wire used for the springs 24di of the central cluster 22a is thinner than the wire used to manufacture the springs 24dii of the central cluster 22b.

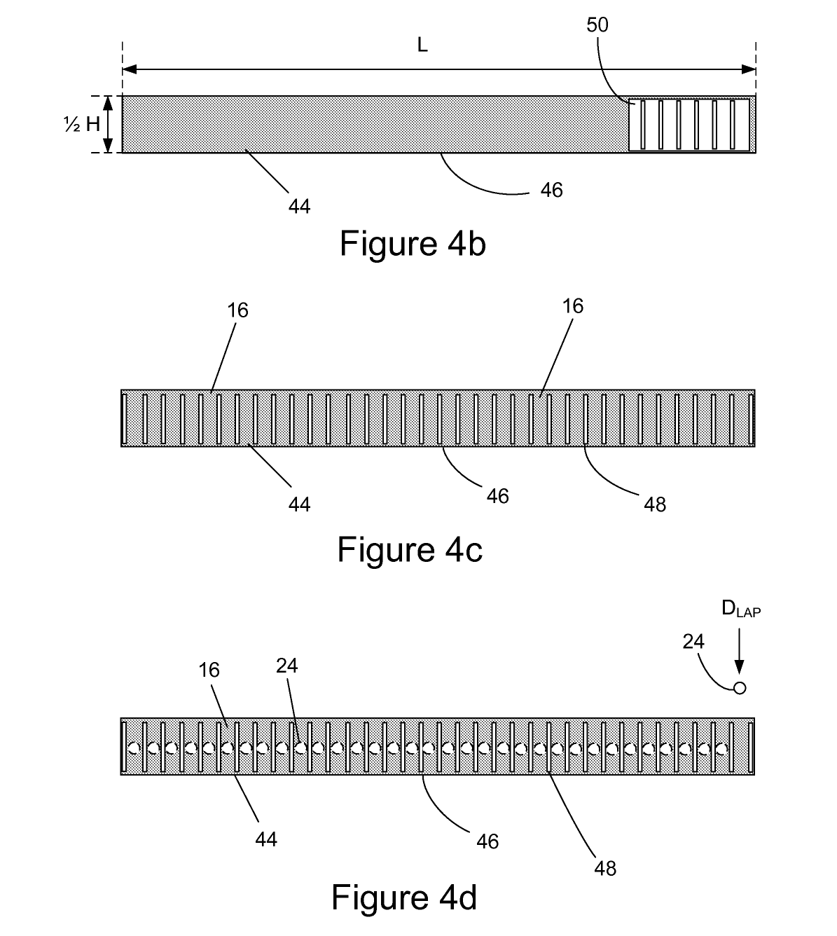

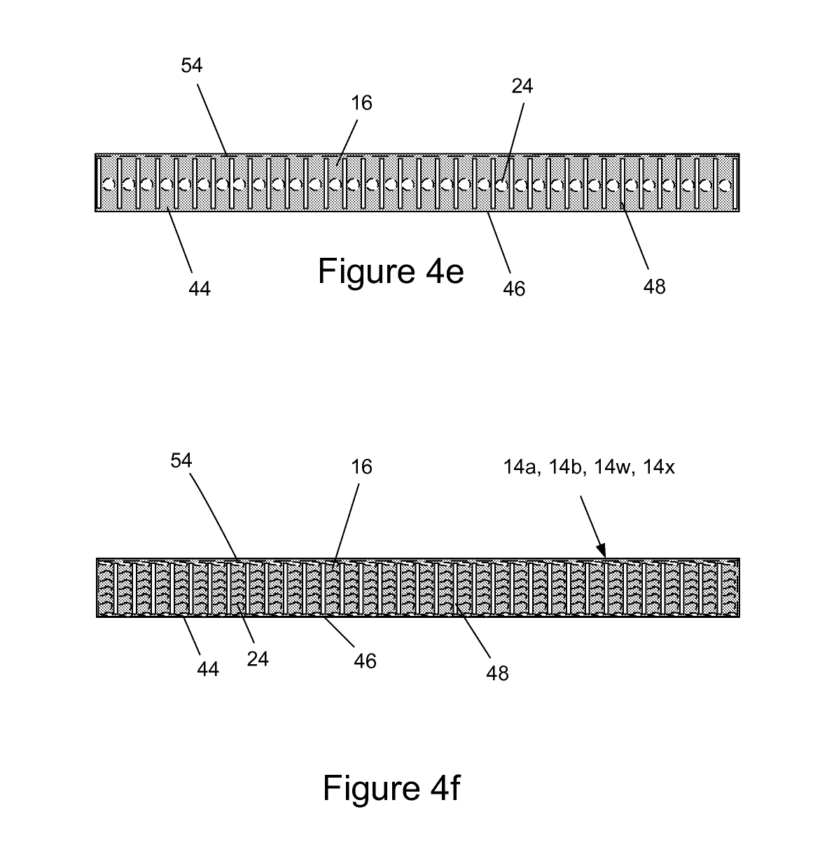

A description of the steps in manufacturing the peripheral strings 14a, 14b, 14w, 14x are set out below with reference to FIGS. 4a to 4f:

a. As particularly shown in FIG. 4a, four sections 44 of material are cut, one for each for border sting 14a, 14b, 14w, 14x of pocket springs 34. Preferably, the material is non-woven. Alternatively, the material is cotton. Preferably, each section 44 of material has a length “L” and a height “2H”.
b. As particularly shown in FIG. 4b, each one of the four sections 44 is folded in half along a lengthwise median crease 46 so that the top half overlies the bottom half. The top and bottom halves of the material 20 are then stitched together with spaced apart seams 48 in the manner shown in FIG. 4c. The seams 48 extend substantially perpendicularly to the direction of the above-mentioned crease, thereby creating pockets 16 for the springs 24. As shown in FIG. 4b, a template 50 is preferably used to indicate the seam positions.
c. As particularly shown in FIG. 4d, the springs 24 for the border strips 14 are then inserted into the pockets 16 of the material 44. Each spring 24 is arranged so that its longitudinal axis D_{LAS} is perpendicular to the longitudinal axis D_{LAP} of the pocket 16.
d. The top and bottom halves of each section 44 of material are then sewn together along a common seam 54, in the manner shown in FIG. 4e, so as to close the pockets 16.
e. The springs 24 of each section 44 of material are then rotated in respective pockets 16 so that the longitudinal axes D_{LAS} of the springs 24 are parallel to the longitudinal axes D_{LAP} of the pockets 16. In doing do the springs 24 resiliently expand within the pockets 16 in the manner shown in FIG. 4f.

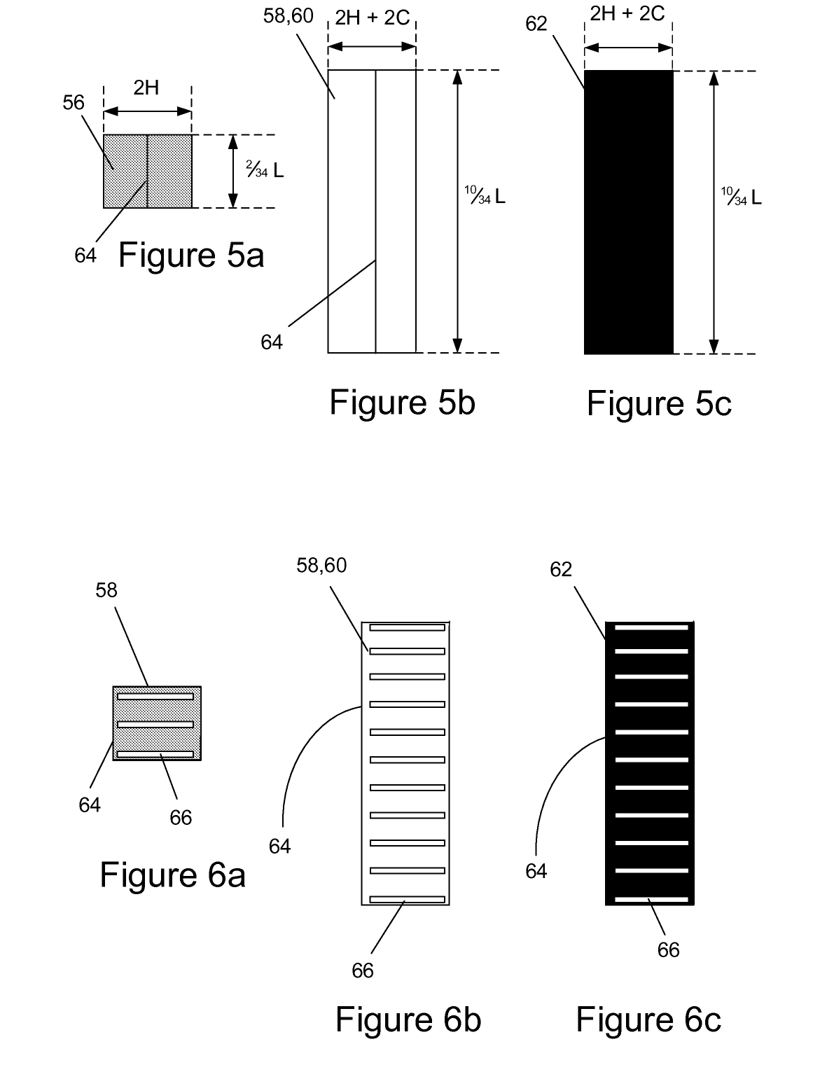

A description of the steps in manufacturing the central strings 14c to 14L of the first half 20a of the mattress core 10 are set out below with reference to FIGS. 5a to 8c:

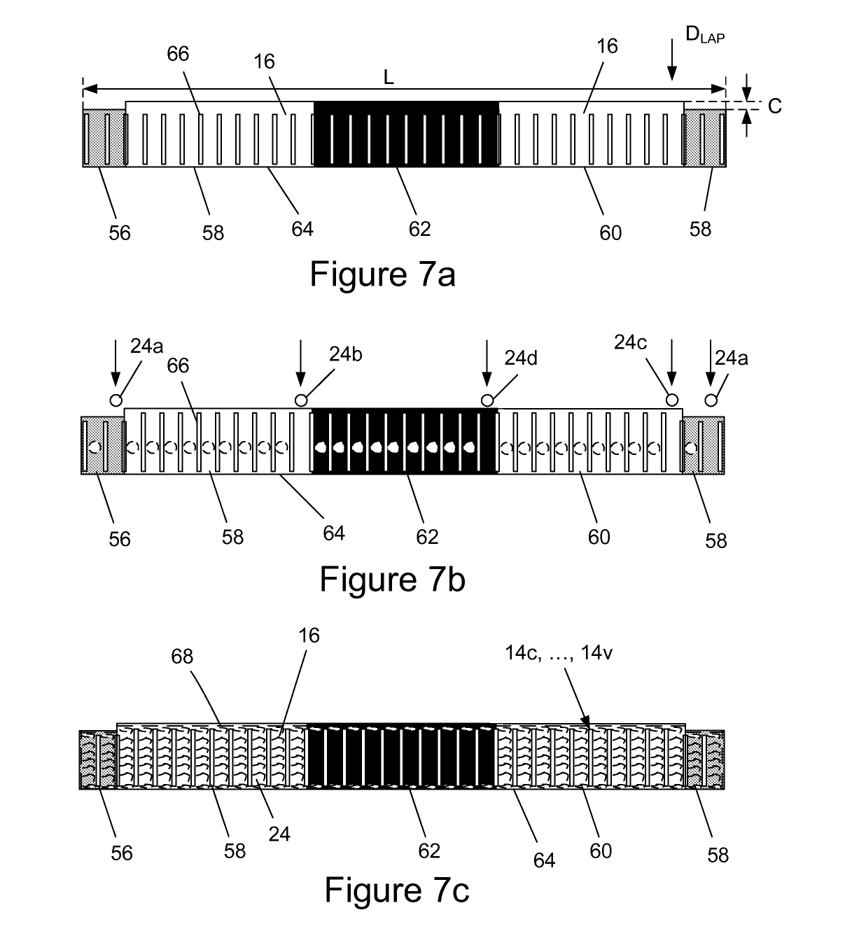

a. As shown in FIGS. 5a to 5c, material is cut for the peripheral 56, head 58, foot 60 and central 62 sections of the central strings 14c to 14L of the first half 20a in the following manner:
i. twenty peripheral sections 56 of material, each section 56 having a length “ 2/34 L” and a height “2H”;
ii. ten head sections 58 of material, each section 58 of material has a length “ 10/34 L” and a height “2H+2C”;
iii. ten foot sections 60 of material, each section 60 of material has a length “ 10/34 L” and a height “2H+2C”;
iv. ten central sections 62 of material, each section 62 of material has a length “ 10/34 L” and a height “2H+2C”.
   b. As particularly shown in FIGS. 6a to 6c, each one of the sections 58 to 62 is folded in half along a lengthwise median crease 64 so that the top half overlies the bottom half. The top and bottom halves of the material are then stitched together with spaced apart seams 66. The seams 66 extend substantially perpendicularly to the direction of the above-mentioned crease 64, thereby creating pockets 16 for the springs 24. A template 50 is preferably used to indicate the seam positions.
   c. Material for each central string 14c to 14L is sewn together so that central sections 62 separate head and foot sections 58, 60 and that peripheral sections 56 are coupled to free ends of respective head and foot sections 58, 60 in the manner shown in FIG. 7a. The combined length of each central string 14c to 14L is “L”.
   d. For each central string 14c to 14L, the following steps are performed in the manner shown in FIG. 7b:
i. The springs 24a for the peripheral sections 56 are inserted into the pockets 16 of the peripheral sections 56;
ii. The springs 24b for the head section are inserted into the pockets 16 of the head sections 58;
iii. The springs 24c for the foot section are inserted into the pockets 16 of the foot sections 60;
iv. The springs 24di for the central section are inserted into the pockets 16 of the central sections 62.

Each spring 24 is arranged so that its longitudinal axis D_{LAS} is perpendicular to the longitudinal axis D_{LAP} of the pocket 16.

e. The top and bottom halves of each string 14c to 14L are then sewn together along a seam 68 so as to close the pockets 16.
f. The springs 24 of each string 14c to 14L are then rotated in respective pockets 16 so that the longitudinal axes D_{LAS} of the springs 24 are parallel to the longitudinal axes D_{LAP} of the pockets 16. In doing do the springs 24 resiliently expand within the pockets 16 in the manner shown in FIG. 7c.

The above-described steps are then performed to manufacture the central strings 14m to 14v of the second half 20b of the mattress core 10. However, springs 24dii are used for the central section 62 instead of the springs 24di.

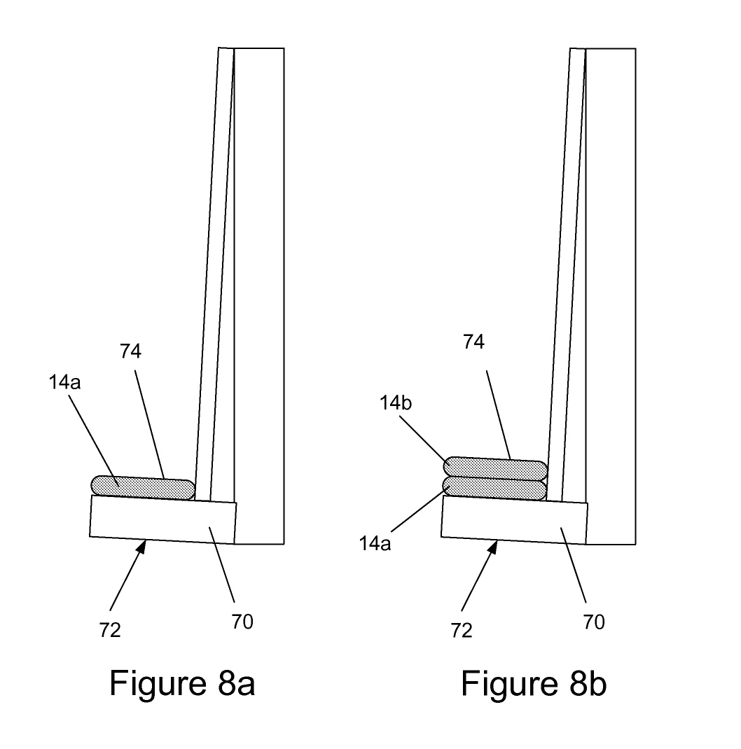

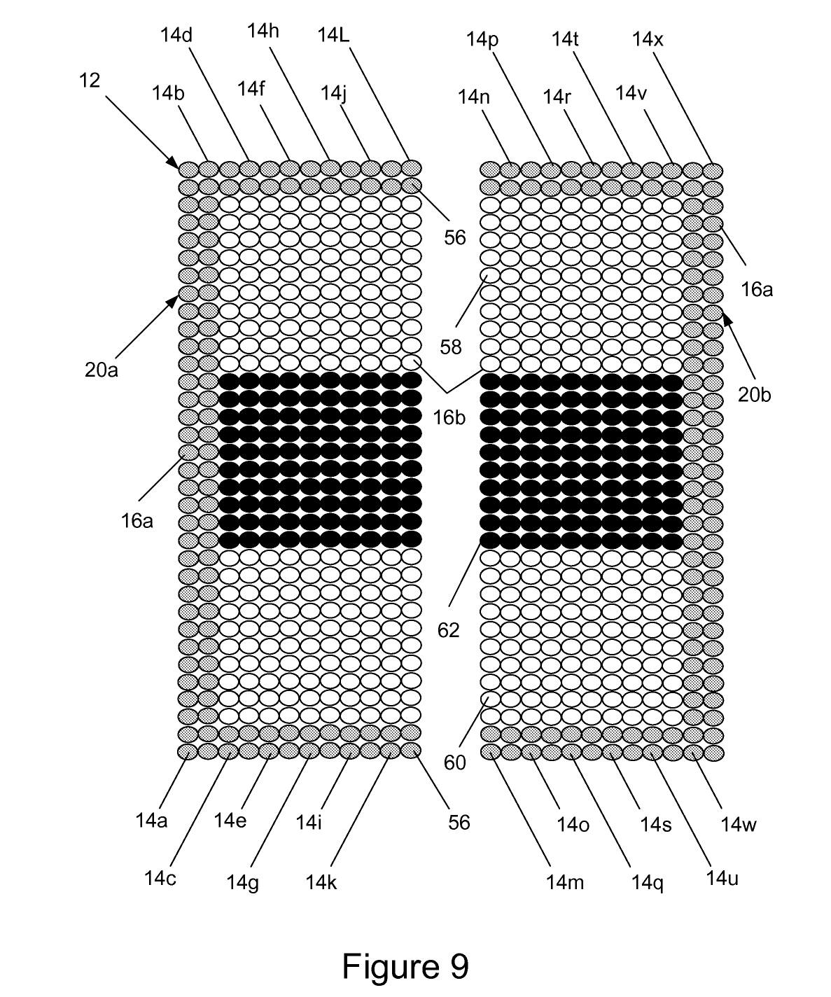

Once all of the strings 14a to 14x have been manufactured, first half 20a of the array 12 of pocket springs 16, as shown in FIG. 9, is then manufactured by:
a. Arranging the first string 14a of pocket springs 16 along a footing 70 of a mattress core construction frame 72 in the manner shown in FIG. 8a;
b. Applying an adhesive to the superior articular side 74 of each pocket spring 16 of the first string 14a of pocket springs 16;
c. Arranging the next string 14b of pocket springs 16 over the previous string 14a of pocket springs 16, in the manner shown in FIG. 8b;
d. Applying an adhesive to the superior articular side 74 of each pocket spring 16 of the next string 14b of pocket springs 16;
e. Repeating steps c and d until all strings 14a to 14L of the first half 20a of the array 12 have been coupled together.

The above-described steps are then repeated to manufacture the second half 20b of the array 12 of pocket springs 16 shown in FIG. 9 using the strings 14m to 14x.

The adhesive is preferably a hot melt glue. Alternatively, any suitable adhesive could be used. The adhesive is preferably applies using a glue gun.

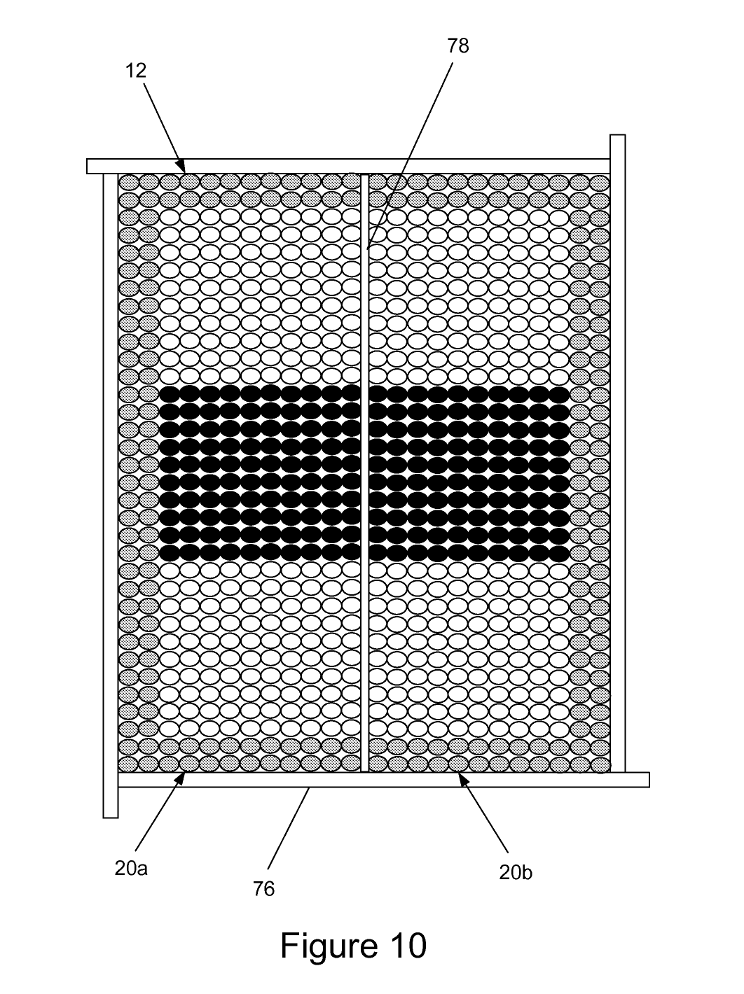

The two halves 20a, 20b of the array 12 of pocket springs 16 are then framed in a box 76 in the manner shown in FIG. 10. The box 76 is of suitable size and shape to fit around the periphery of the array 12 in the manner shown. A barrier 78 is arranged between the two halves 20a, 20b of the array 12 as they are placed in the box 76. The box 76 exerts a compressive force on the array 12.

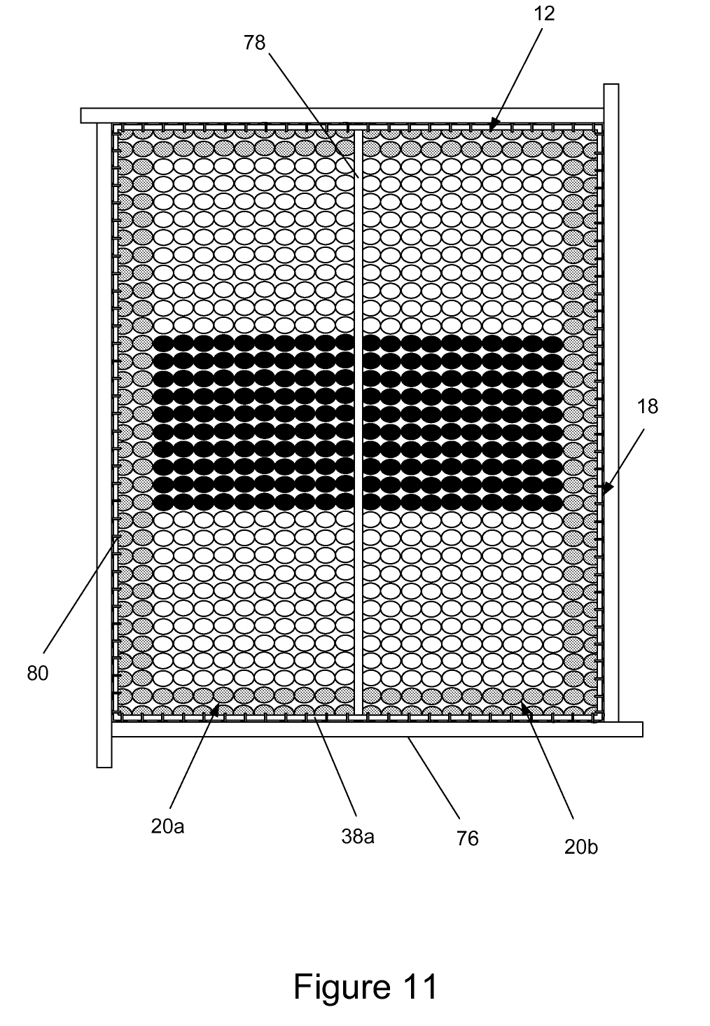

Once arranged in the box 76, the above-described upper and lower rectangular peripheral borders 18a, 18b are arranged around the upper and lower peripheral edges 40a, 40b of pocket springs 16 of the array 12 in the manner shown in FIG. 11. The borders 18a, 18b are preferably made of metal. Alternatively, the borders are made of plastic. The upper and lower borders 18a, 18b are coupled to upper and lower sections of springs 24 of the peripheral pocket springs 16 with fasteners 80. The fasteners 80 are preferably metal couplings.

Advantageously, the mattress core has the following dimensions:

### L=210 cm

### W=200 cm

### H=10 to 30 cm

### C=1 to 5 cm

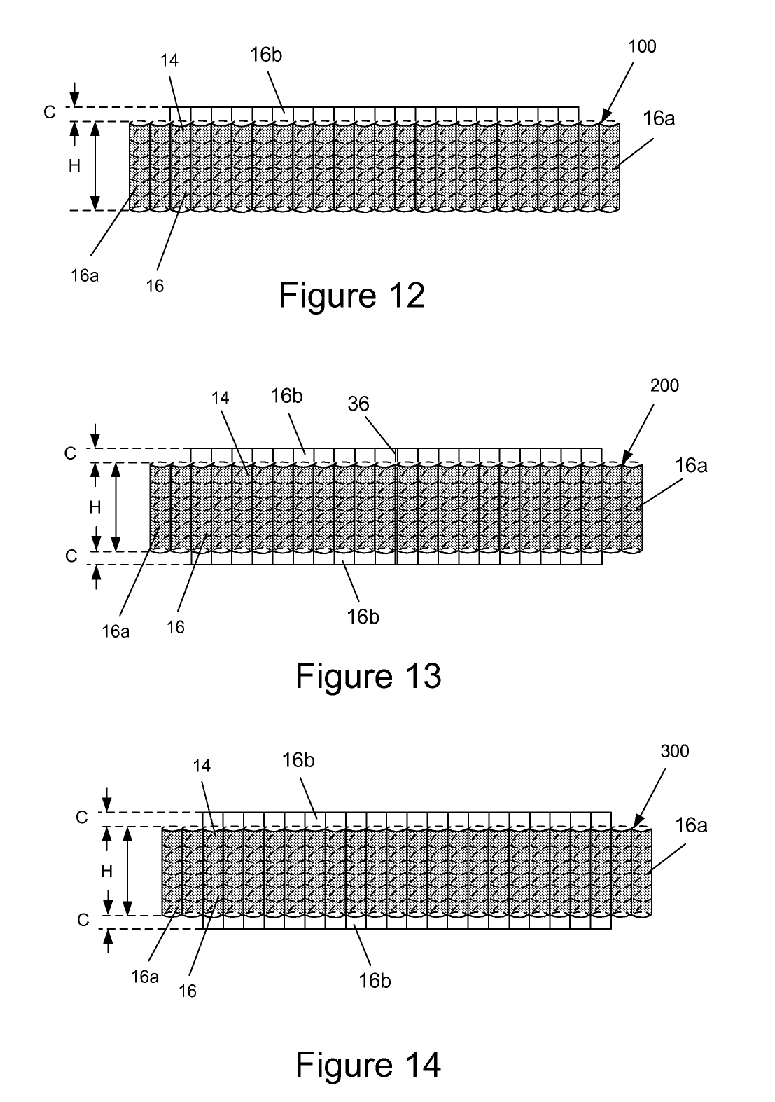

Alternative mattress cores 100, 200, 300 are shown in FIGS. 12 to 14. The mattress core 100 is constructed in accordance with the above described method steps. However, the mattress core 100 is formed as a single unit rather than two halves. The mattress core 200 is constructed in accordance with the above described method steps. However, the peripheral pocket springs 16a are stepped down from upper and lower sides of the mattress core 200. The mattress core 300 is constructed in accordance with the above described method steps. However, mattress core 300 is formed as a single unit rather than two halves and the peripheral pocket springs 16a are stepped down from upper and lower sides of the mattress core 200.

Many modifications will be apparent to those skilled in the art without departing from the scope of the present invention

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that the prior art forms part of the common general knowledge in Australia.

1. A mattress core including:
(a) an array of strings of pocket springs extending in parallel across the mattress core; and
(b) a fastener coupling the array of pocket springs together,
wherein peripheral pocket springs located in peripheral sections of the array are stepped down from crown pocket springs which are framed by the peripheral pocket springs.

2. The mattress core claimed in claim 1, wherein the crown pocket springs are substantially the same height.

3. The mattress core claimed in claim 1, wherein the peripheral pocket springs frame four sides of the crown pocket springs.

4. The mattress core claimed in claim 1, wherein the peripheral pocket springs frame three sides of the crown pocket springs.

5. The mattress core claimed in claim 1, wherein the array is formed in first and second halves, each having peripheral pocket springs located in non-adjoining peripheral sections of the array.

6. The mattress core claimed in claim 1, wherein the peripheral pocket springs are stepped down from the crown pocket springs on top and bottom sides of the mattress core.

7. The mattress core claimed in claim 1, wherein first and second halves of the array each include a central cluster of pocket springs, a rate of springs of pocket springs of the central cluster the first one of said halves being less than a rate of springs of pocket springs of the central cluster of the second one of said halves.

8. The mattress core claimed in claim 7, wherein the strings extend between a head and foot of the mattress core.

9. The mattress core claimed in claim 7, wherein the first and second halves of the array each include head and foot clusters of pocket springs separated by respective central clusters of pocket springs.

10. The mattress core claimed in claim 9, wherein rates of springs of the head and foot clusters of pocket springs of the first and second halves of the array are less than rates of springs of respective central clusters of pocket springs.

11. The mattress core claimed in claim 10, wherein centrally disposed strings of pocket springs include pocket springs in said head, central and foot clusters.

12. The mattress core claimed in claim 8, wherein springs of said peripheral of pocket springs have a rate less than the rate of springs of the head and foot clusters of the first and second halves of the array.

13. The mattress core claimed in claim 8, wherein first half and the second half of the mattress core are separated by a barrier.

14. The mattress core claimed in claim 13, wherein barrier includes a section of foam.

15. The mattress core claimed in claim 1, wherein opposed articular surfaces of said strings of pocket springs are coupled together with an adhesive.

16. The mattress core claimed in claim 1, wherein the fastener includes top and bottom rectangular peripheral bands respectively coupled to top and bottom sections of peripheral pocket springs of the array.

17. The mattress core claimed in claim 16, wherein the top and bottom rectangular peripheral bands are respectively coupled to top and bottom sections of peripheral pocket springs with clips.

18. A mattress including the mattress core claimed in claim 1.

19. A method of manufacturing a mattress core including the step of coupling a series of strings of pocket springs together with a fastener to form an array of strings of pocket springs, wherein peripheral pocket springs located in peripheral sections of the array are stepped down from crown pocket springs which are framed by the peripheral pocket springs.

20. The method claimed in claim 19, wherein the crown pocket springs are substantially the same height.

21. The method claimed in claim 19, wherein the array is formed in first and second halves, each having peripheral pocket springs located in non-adjoining peripheral sections of the array.

22. The method claimed in claim 19, wherein the peripheral pocket springs are stepped down from the crown pocket springs on top and bottom sides of the mattress core.

23. The method claimed in claim 19, wherein first and second halves of the array each include a central cluster of pocket springs, a rate of springs of pocket springs of the central cluster the first one of said halves being less than a rate of springs of pocket springs of the central cluster of the second one of said halves.

24. The method claimed in claim 22, wherein the strings extend between a head and foot of the mattress core.

25. The method claimed in 23, wherein the first and second halves of the array each include head and foot clusters of pocket springs separated by respective central clusters of pocket springs.

26. The method claimed in claim 25, wherein rates of springs of the head and foot clusters of pocket springs of the first and second halves of the array are less than rates of springs of respective central clusters of pocket springs.

27. The method claimed in claim 26, wherein centrally disposed strings of pocket springs include pocket springs in said head, central and foot clusters.

28. The method claimed in claim 19, wherein step of coupling includes the step of applying an adhesive between opposed articular surfaces of pocket springs in opposed strings.

29. The method claimed in claim 19, including the step of coupling top and bottom rectangular peripheral bands respectively to top and bottom sections of peripheral pocket springs of the array.

30. The method claimed in claim 29, wherein the top and bottom rectangular peripheral bands are respectively coupled to top and bottom sections of peripheral pocket springs with clips.
